(19) United States
(12) Patent Application Publication
(10) Pub. No.: US 2026/0246907 A1
(43) Pub. Date: Aug. 20, 2026

(54) SYSTEM AND METHOD FOR CAMERA CALIBRATION

(71) Applicants: Digital Surgery Limited, London (GB); Covidien LP, Mansfield, MA (US)

(72) Inventors: Meir Rosenberg, Newton, MA (US); Faisal I Bashir, Andover, MA (US); Max L. Balter, Boston, MA (US); Emanuele Colleoni, London (GB); Avinash Ayite, Roxbury, MA (US)

(21) Appl. No.: 19/159,848

(22) PCT Filed: Mar. 7, 2024
(86) PCT No.: PCT/EP2024/056097

§ 371 Date: Aug. 26, 2025

Related U.S. Application Data
(60) Provisional application No. 63/450,712, filed on Mar. 8, 2023.
(60) Provisional application No. 63/450,715, filed on Mar. 8, 2023.
(60) Provisional application No. 63/552,762, filed on Feb. 13, 2024.

(51) Int. Cl. H04N 13/246; G06T 7/80; H04N 13/296

(52) U.S. Cl. CPC H04N 13/246; G06T 7/85; H04N 13/296; G06T 2207/10012; G06T 2207/10068

(57) ABSTRACT

An imaging system includes a stereoscopic camera having a first sensor configured to output a first image in a first channel and a second sensor configured to output a second image in a second channel. The system also includes an image processing device coupled to the stereoscopic camera. The image processing device includes a processor configured to perform a calibration process of the stereoscopic camera. The process includes generating a first map based on the first image of the first channel and a second map based on the 10% second image of the second channel, generating a first surface based on the first map for first channel and generating a second surface based on the second map for the second channel; generating a virtual volume enclosed between the first surface and the second surface. The process also includes determining whether the first and second images are displayed within the virtual volume, indicating calibration of the stereoscopic camera is successful based on the first and second images are displayed within the virtual volume, and enabling imaging operation of the stereoscopic camera.

### BACKGROUND

Laparoscopic or endoscopic visualization systems provide surgeons with still and/or video images during laparoscopic procedures. Traditional endoscopy involves the use of cameras to record the visual field and display the acquired image on a screen for the surgeon's view. In Minimally Invasive Surgery (MIS), the laparoscope is often a monocular endoscopic camera, while in Robotic Assisted Surgery (RAS), the endoscopic camera is often binocular stereoscopic camera that provides depth perception to surgeon during the procedure. In recent years with the advent of computational image processing, both monocular and stereoscopic endoscopes are increasingly used in depth mapping of the surgical scene. A number of methods have been developed to reconstruct the surgical scene in 2.5D over single and multiple monocular or stereo-pair images, including stereo reconstruction, Structure from Motion (SfM) and Simultaneous Localization and Mapping (SLAM).

Depth mapping of a surgical site has numerous applications in MIS and RAS including avoiding critical structures and Augmented Reality (AR) overlay of pre-operative imaging model. In order for these RAS applications to be clinically reliable, the intrinsic and extrinsic parameters of the cameras must be accurately calibrated for robust stereo reconstruction. Traditionally, stereo camera calibration is performed using checkerboard targets, which are placed at known positions in the scene. The cameras are then used to acquire images of the targets, and the positions of the checkerboard corners in the images are used to estimate the intrinsic and extrinsic parameters of the cameras. However, in MIS or RAS application in the operating room, the use of checkerboard targets and time-consuming calibration is less desirable. Furthermore, camera calibration parameters may change over time and/or use especially after autoclaving and sterilization processing, and periodic recalibration may be required. Thus, there is a need for a system and method to verify accurate calibration without checkerboard targets and provide for calibration of the camera before and during each use.

### SUMMARY

The present disclosure provides a system and method for calibrating a laparoscopic or endoscopic camera. The camera may be a monocular laparoscope routinely used in MIS or a binocular stereo endoscope routinely used in RAS. According to one embodiment of the present disclosure, an imaging system is disclosed. The imaging system includes a stereoscopic camera having a first sensor configured to output a first image in a first channel, a second sensor configured to output a second image in a second channel, and an image processing device coupled to the stereoscopic camera. The image processing device includes a processor configured to detect a first plurality of features in the first image of the first channel, detect a second plurality of features in the second image of the second channel, and generate a crossmatch of the first and second plurality of features. The processor is further configured to transform the crossmatch to obtain a plurality of transform parameters and compare the plurality of transform parameters to a plurality of extrinsic calibration parameters of the stereoscopic camera. The processor is additionally configured to validate calibration of the stereoscopic camera based on comparison of the transform parameters to the extrinsic calibration parameters, and output a message indicating whether the calibration of the stereoscopic camera is validated.

Implementations of the above embodiment may include one or more of the following features. According to one aspect of the above embodiment, the imaging system may include a monitor configured to display the first image and the second image. The monitor may be further configured to display the message indicating whether the calibration of the stereoscopic camera is validated. The processor may be further configured to compare a difference between at least one transform parameter of the plurality of transform parameters and at least one calibration parameter of the plurality of extrinsic calibration parameters to a threshold. The message may be an alert indicating that validation of the calibration failed, and the processor may be configured to generate the alert in response to the difference being larger than the threshold. The message may also be a prompt indicating that validation of the calibration succeeded, and the processor may be configured to generate the prompt in response to the difference being smaller than the threshold. The processor may be further configured to load the calibration parameters as well as threshold from the camera.

According to another embodiment of the present disclosure, an imaging system is disclosed. The imaging system includes a stereoscopic camera having a first sensor configured to output a first image in a first channel and a second sensor configured to output a second image in a second channel. The system also includes an image processing device coupled to the stereoscopic camera. The image processing device includes a processor configured to generate a depth map based on the first image of the first channel and the second image of the second channel. The depth map generation may involve loading monocular or stereo camera calibration parameters, rectifying the images to remove lens distortions, and computing a dense disparity map. The processor is also configured to generate a first surface based on the depth map for first channel and generate a second surface based on the depth map for the second channel. The processor is further configured to generate a virtual volume enclosed between the first surface and the second surface and display the virtual volume over the first image and the second image.

Implementations of the above embodiment may include one or more of the following features. According to one aspect of the above embodiment, the imaging system may also include a monitor configured to display the virtual volume over the first image and the second image. The processor may be further configured to output a prompt on the monitor asking whether the first image and the second image are displayed within the virtual volume to confirm calibration of the stereoscopic camera. The processor may be further configured to receive a user response in response to the prompt. The processor may be further configured to output an alert indicating that validation of the calibration failed in response to a negative response to the prompt. The processor may be further configured to output a message indicating that validation of the calibration succeeded in response to an affirmative response to the prompt. The processor may be further configured to generate the virtual volume based on an error value. The processor may be further configured to load the error value from the camera.

According to a further embodiment of the present disclosure, a method for validating calibration of a stereoscopic camera is disclosed. The method includes capturing a first image in a first channel at a first sensor of a stereoscopic camera and capturing a second image in a second channel at a second sensor of the stereoscopic camera. The method also includes generating, at a processor, a depth map based on the first image of the first channel and the second image of the second channel. The method also includes generating, at the processor, a first surface based on the depth map for first channel, a second surface based on the depth map for the second channel, and a virtual volume enclosed between the first surface and the second surface. The method also includes displaying the virtual volume over the first image and the second image.

Implementations of the above embodiment may include one or more of the following features. According to one aspect of the above embodiment, the method may include displaying on a monitor the virtual volume over the first image and the second image. In addition, or alternatively to the depth map and generation, key points or landmarks may be detected on known surfaces and/or structures (e.g. surgical instruments), where the distances between key points and landmarks are known. These maps may be used to refine calibration. The key points and/or landmarks may be displayed and highlighted in the volume. The method may further include outputting a prompt on the monitor asking whether the first image and the second image are displayed within the virtual volume to confirm calibration of the stereoscopic camera. The method may additionally include receiving, at the processor, a user response to the prompt. The method further may include outputting on the monitor an alert indicating validation of the calibration failed in response to a negative response to the prompt, and outputting on the monitor a message indicating validation of the calibration succeeded in response to an affirmative response to the prompt.

Implementations of the above embodiment may include one or more of the following features. According to one aspect of the above embodiment, the method may include, upon failure of the validation test, displaying to the user rectified images and virtual volume (e.g., point cloud) as well as a set of slider controls for a plurality of calibration parameters. The method may rank the plurality of calibration parameters by their significance of impact on the form of the depth map and the virtual volume (e.g., point cloud). The method may also limit a range of each slider for each ranked calibration parameter to a limited set of values for user interaction. The range of values may be generated based on an optimization mechanism. The method may additionally include receiving, at processor, a user response in the form of adjustments to the plurality of sliders each labeled with the name of the calibration parameter ranked by importance. The user responses may be saved as user preferences in the imaging system. The method may generate rectified images, depth map, and point cloud in real time based on each user input to the sliders. The method may additionally include receiving, at processor, a user response at the end of the interactive calibration parameter optimization process indicating that the generated rectified images are aligned vertically. The method may additionally include receiving, at processor, a user response at the end of the interactive calibration parameter optimization process indicating that the first image and the second image are displayed within the virtual volume (point cloud) to confirm calibration of the stereoscopic camera. The method may additionally include receiving, at the processor, a user response to the prompt. The method further may include outputting on the monitor an alert indicating the passage or failure of the semi-automatic calibration parameter optimization process.

Implementations of the above embodiment may include one or more of the following features. According to one aspect of the above embodiment, the method may include displaying on a monitor the rectified left and right channel images of binocular stereo endoscope along with epipolar lines. The method may further include outputting a prompt on the monitor asking whether the epipolar lines displayed on the first image and the second image are aligned in the vertical direction. The method may additionally include receiving, at the processor, a user response to the prompt. The method further may include outputting on the monitor an alert indicating validation of the calibration failed in response to a negative response to the prompt, and outputting on the monitor a message indicating validation of the calibration succeeded in response to an affirmative response to the prompt.

Implementations of the above embodiment may include one or more of the following features. According to one aspect of the above embodiment, the method may include a process to estimate the intrinsic and extrinsic camera parameters from known or unknown objects in the robotic system's operating environment. This feature is based on the observation that the system can load the factory-calibrated camera parameters from memory and use the acquired images to optimize the camera parameters in case of verification failure. The method may present the user with an interface that displays the left and right channel stereo pair images and lets the user select a few matching points on both left and right channel images. A deep learning, or another machine learning image processing algorithm may automatically detect landmarks and/or key points. The method may additionally optimize the intrinsic and extrinsic camera parameters to produce the final output where the similar features in both left and right channel images line up on the same epipolar lines resulting in optimal rectification and accurate stereo reconstruction.

Implementations of the above embodiment may include one or more of the following features. According to one aspect of the above embodiment, the method may include a target-free method of self-calibration from intra-operative images at the very beginning of the surgical procedure. The method may use the first stereo pair images to predict two dense depth maps from the perspective of the left and the right cameras using a classical or deep learning method of stereo reconstruction. The method may use the predicted depth maps and the camera calibration parameters to generate predicted point clouds from the first set of stereo pair images. The method may further process the second pair of stereo pair images from the previous time stamp in order to estimate the relative pose of the stereo endoscope in the surgical site by a combination of visual SLAM and forward kinematics of the robotic arm holding the stereo endoscope based on the first and the second stereo pair images. The method may use the warped predicted point cloud and the actual first stereo pair images to synthetically generate the second pair of synthetic images. The view synthesized left and right images may be subtracted from the actual second stereo pair images to generate the left and right visual loss images. The method may use the visual loss images to optimize the intrinsic and extrinsic camera parameters until the visual loss is below a threshold. The calibration parameters optimization method might be based on a classical or reinforcement learning algorithm that starts the optimization from the initial factory camera calibration parameters loaded from the camera or the system memory. In addition to point clouds, key points may also be used. A key point detector may be used to find high fidelity key points in the left and right images (or monocular, over time) to boost rectification and calibration. The key points may be also displayed over the volume.

According to a further embodiment of the present disclosure, a method for intra-operative calibration of a stereoscopic camera is disclosed. The method includes capturing a first stereo pair image from a stereoscopic camera, capturing a second stereo pair image from the stereoscopic camera, generating, at a processor, a predicted point cloud using a plurality of calibration parameters, and generating, at the processor, a warped stereo pair image based on the second stereo pair image and the predicted point cloud. The method also includes generating, at the processor, a visual loss image representing a calibration parameters error, optimizing the plurality of calibration parameters to minimize the visual loss, and displaying a third stereo pair image on a monitor using the optimized plurality of camera calibration parameters.

Implementations of the above embodiment may include one or more of the following features. According to one aspect of the above embodiment, the method may include generating, at the processor, a depth map from the plurality of calibration parameters. The method may also include generating, at the processor, the predicted point cloud from the depth map. The method may further include generating, at the processor, a predicted pose of the stereoscopic camera. The method may additionally include generating, at the processor, the warped stereo pair image based on the predicted pose. Generation of the predicted pose may be based on kinematics data of a robotic arm controlling movement of the stereoscopic camera. The method may also include saving the plurality of optimized camera calibration parameters in a memory.

According to yet another embodiment of the present disclosure, an imaging system is disclosed. The imaging system includes a stereoscopic camera, a monitor displaying images captured by the stereoscopic camera, and an image processing device coupled to the stereoscopic camera and the monitor. The image processing device includes a processor configured to capture a first stereo pair image from the stereoscopic camera, capture a second stereo pair image from the stereoscopic camera, and generate a predicted point cloud using a plurality of camera calibration parameters. The processor is further configured to generate a warped stereo pair image based on the second stereo pair image and the predicted point cloud, generate a visual loss image representing a calibration parameters error, optimize the plurality of camera calibration parameters to minimize the visual loss, and display on the monitor a third stereo pair image using the optimized plurality of camera calibration parameters.

Implementations of the above embodiment may include one or more of the following features. According to one aspect of the above embodiment, the system may further include a robotic arm holding the stereoscopic camera. The image processing device may be further configured to generate a predicted pose of the stereoscopic camera based on kinematics data of the robotic arm.

According to a further embodiment of the present disclosure, an imaging system is disclosed. The imaging system includes a stereoscopic camera having a first sensor configured to output a first image in a first channel and a second sensor configured to output a second image in a second channel. The system also includes an image processing device coupled to the stereoscopic camera. The image processing device includes a processor configured to perform a calibration process of the stereoscopic camera. The process includes generating a first map based on the first image of the first channel and a second map based on the second image of the second channel, generating a first surface based on the first map for first channel and generating a second surface based on the second map for the second channel; generating a virtual volume enclosed between the first surface and the second surface. The process also includes determining whether the first and second images are displayed within the virtual volume, indicating calibration of the stereoscopic camera is successful based on the first and second images are displayed within the virtual volume, and enabling imaging operation of the stereoscopic camera.

Implementations of the above embodiment may include one or more of the following features. According to one aspect of the above embodiment, the calibration process may further include indicating that calibration of the stereoscopic camera failed based on at least one of the first image or the second image being displayed within the virtual volume and disabling imaging operation of the stereoscopic camera. The processor may be further configured to repeat the calibration process in response to calibration failure. The first map and the second map may be at least one of a depth map or a surface normal map. The processor may be further configured to display the virtual volume over the first image and the second image. The imaging system may include a monitor configured to display the virtual volume over the first image and the second image. The monitor may be a heads-up display. The processor may be further configured to output on the monitor a prompt asking whether the first image and the second image are displayed within the virtual volume. The processor may be further configured to receive a user response in response to the prompt. The processor may be additionally configured to output an alert indicating calibration validation failed in response to a negative user response. The processor may be also configured to output a message indicating calibration validation succeeded in response to an affirmative user response. The processor may be further configured to generate the virtual volume based on an error value. The processor may be additionally configured to load the error value from the stereoscopic camera. The imaging processing device may also include a memory and the processor is further configured to load the error value from the memory.

### BRIEF DESCRIPTION OF THE DRAWINGS

The present disclosure may be understood by reference to the accompanying drawings, when considered in conjunction with the subsequent, detailed description, in which:

FIG. 1 is a schematic diagram of an imaging system according to an embodiment of the present disclosure;

FIG. 2 is a perspective view of a stereoscopic, endoscopic camera of the imaging system of FIG. 1;

FIGS. 3A and 3B are schematic diagrams of an image processing unit according to an embodiment of the present disclosure;

FIG. 4 is a perspective view of a surgical robotic system including the imaging system according to an embodiment of the present disclosure;

FIG. 5 is a flow chart of a method for performing automatic calibration of an endoscopic camera of the imaging system according to an embodiment of the present disclosure;

FIG. 6 is a schematic diagram of a stereoscopic camera performing calibration according to an embodiment of the present disclosure;

FIG. 7 is a flow chart of a method for performing automatic calibration of an endoscopic camera of the imaging system according to another embodiment of the present disclosure;

FIG. 8 is a flow chart of a method for performing automatic calibration during white balance calibration according to an embodiment of the present disclosure;

FIG. 9 is a flow chart of an intra-operative calibration method for correcting for the camera calibration parameters after the verification fails according to an embodiment of the present disclosure;

FIG. 10 shows a stereoscopic pair of images rectified using accurate calibration parameters;

FIG. 11 shows a stereoscopic pair of images rectified using sub-optimal camera calibration parameters;

FIG. 12 shows a graphical user interface (GUI) displaying interactive semi-automatic method of parameter optimization according to an embodiment of the present disclosure; and

FIG. 13 shows a virtual volume generated from point clouds generated using parameters adjusted through the GUI of FIG. 12.

### DETAILED DESCRIPTION

Embodiments of the presently disclosed system are described in detail with reference to the drawings, in which like reference numerals designate identical or corresponding elements in each of the several views. In the following description, well-known functions or constructions are not described in detail to avoid obscuring the present disclosure in unnecessary detail. Those skilled in the art will understand that the present disclosure may be adapted for use with any imaging system.

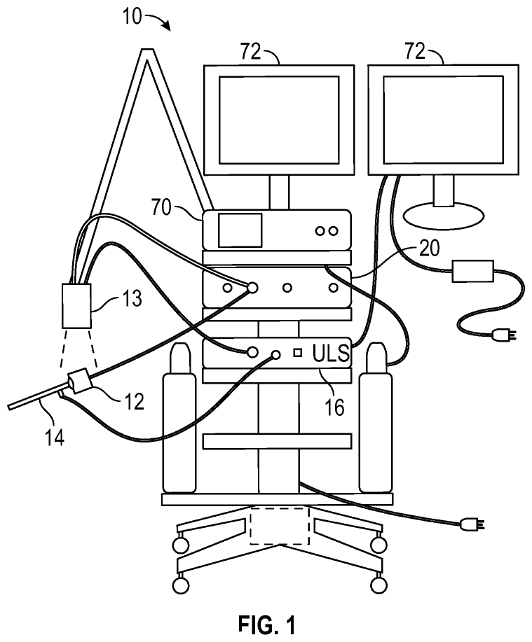

With reference to FIG. 1, an imaging system 10 includes an image processing unit 20 configured to couple to one or more cameras, such as an endoscopic camera 12 that is configured to couple to an endoscope 14 or an open surgery camera 13. The system 10 also includes a light source 16 coupled to the cameras 12 and 13. The light source 16 may include any suitable light source, e.g., white light, near infrared, etc., having light emitting diodes, lamps, lasers, etc.

The image processing unit 20 is configured to receive image and process raw image data signals from the cameras 12 and 13, and generate blended white light, NIR images for recording and/or real-time display. The image processing unit 20 is also configured to blend images using various AI image augmentations.

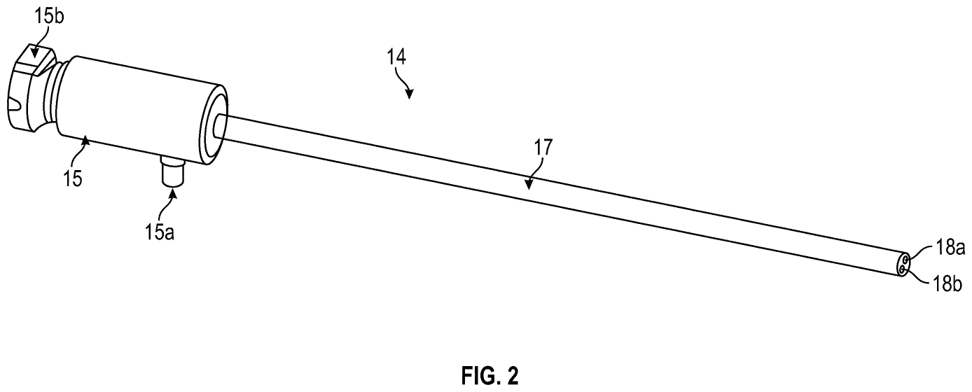

With reference to FIG. 2, the endoscope 14 is shown as a stereoscopic endoscope having a housing 15 and a shaft 17 extending distally therefrom. The endoscope 14 also includes a pair of objectives 18a and 18b (i.e., first and second optical channels for left and right) disposed at a distal end of the shaft 17. The endoscope 14 also includes a fiber optic input adapter 15a which extends radially from the housing 15. The housing 15 includes a proximal coupling interface 15b configured to engage the camera 12 with a pair of output optical elements (not shown). The endoscope 14 may include a plurality of lenses, prisms, mirrors, etc. to enable light transmission from the objectives 18a and 18b to the output elements. In further embodiments, the endoscope 14 may be a monocular endoscope, in which case, a single image channel through a single objective and optical output elements is provided to the camera 12.

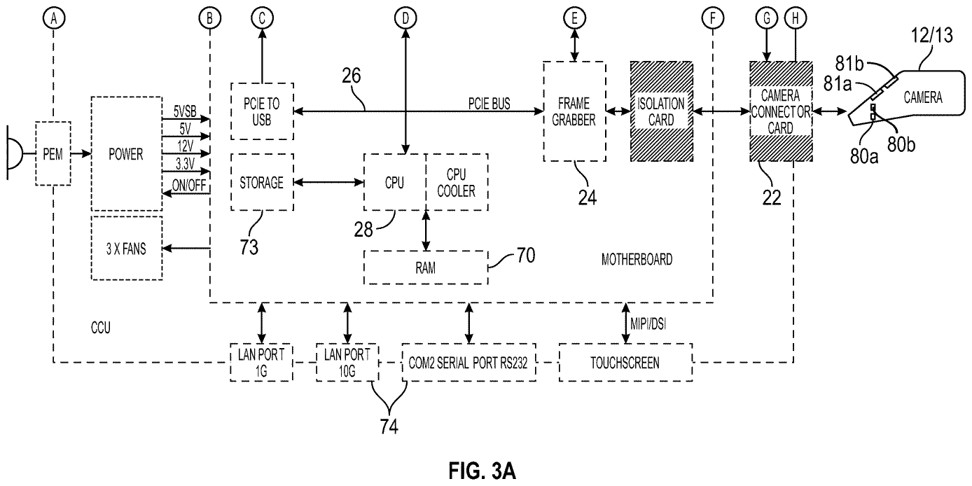

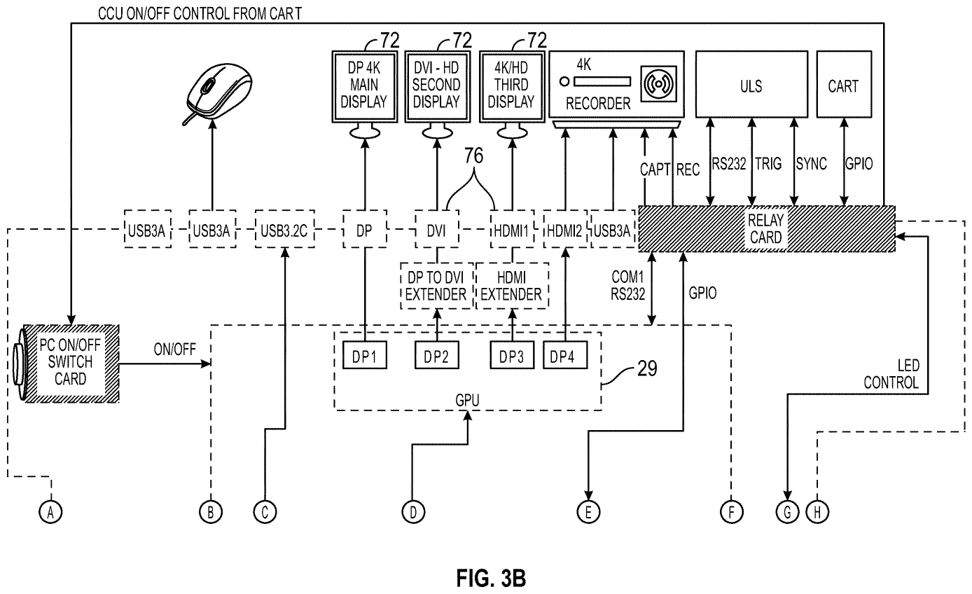

With reference to FIGS. 3A and 3B, the image processing unit 20 is connected to the cameras 12 and 13 through a camera connector 22, which is in turn coupled to a frame grabber 24, which is configured to capture individual, digital still frames from a digital video stream. The frame grabber 24 is coupled via peripheral component interconnect express (PCI-E) bus 26 to a first processing unit 28 and a second processing unit 29. The first processing unit 28 may be configured to perform operations, calculations, and/or sets of instructions described in the disclosure and may be a hardware processor, a field programmable gate array (FPGA), a digital signal processor (DSP), a central processing unit (CPU), a microprocessor, and combinations thereof. Those skilled in the art will appreciate that the processor may be any logic processor (e.g., control circuit) adapted to execute algorithms, calculations, and/or sets of instructions as described herein. The second processing unit 29 may be a graphics processing unit (GPU) or an FPGA, which is capable of more parallel executions than a CPU (e.g., first processing unit 28) due to a larger number of cores, e.g., thousands of compute unified device architecture (CUDA) cores, making it more suitable for processing images.

The image processing unit 20 also includes various other computer components, such as memory 70, a storage device 73, peripheral ports 74, input device (e.g., touch screen). Additionally, the image processing unit 20 is also coupled to one or more monitors 72 via output ports 76. The image processing unit 20 is configured to output the processed images through any suitable video output port, such as a DISPLAYPORT™, HDMI®, SDI, etc., that is capable of transmitting processed images at any desired resolution, display rate, and/or bandwidth.

With continued reference to FIGS. 3A and 3B, the cameras 12 and 13 include a pair of visible (VIS) image sensors 80a and 80b for stereoscopic white light (i.e., visible light) imaging (e.g., from about 380 nm to about 700 nm) and separate near infrared (NIR) image sensors 81a and 81b for capturing NIR fluorescent light (e.g., wavelength from about 825 nm to about 850 nm). The VIS image sensors 80a and 80b may include a Bayer filter or any other filter suitable for color single chip imaging. In embodiments, the cameras 12 and 13 may also use multiple color sensors, e.g., one sensor per color (RGB) channel.

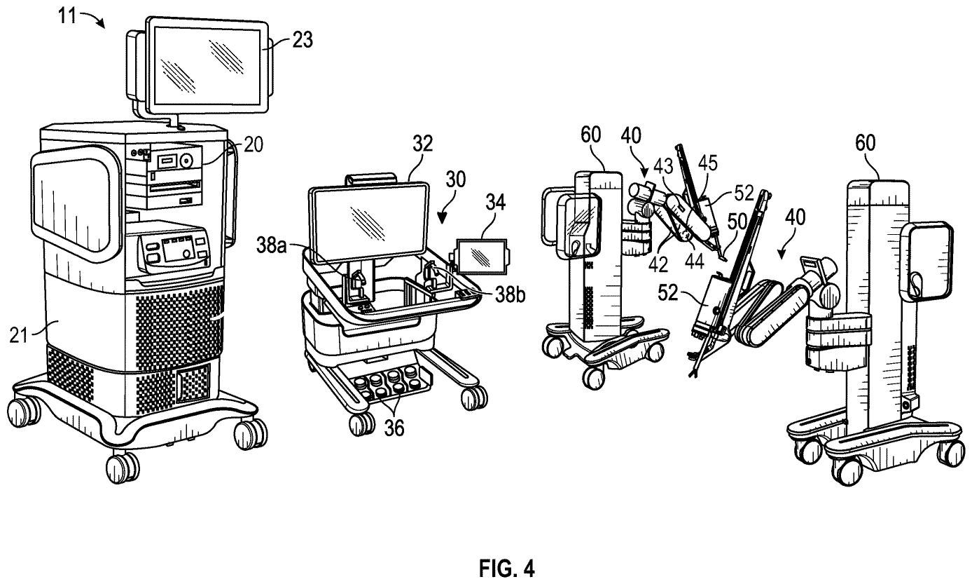

The imaging system 10 may be also integrated with a surgical robotic system 11, which is shown in FIG. 4. A control tower 21 is connected to all of the components of the surgical robotic system 11 including a surgeon console 30 and one or more movable carts 60. Each of the movable carts 60 includes a robotic arm 40 having an attached device, which may be the endoscopic camera 12. Each of the robotic arms 40 includes a plurality of links 42 movable relative to each other about joints 44, which may have any number of degrees of freedom, e.g., 1 or more, providing multiple degrees of freedom to the robotic arm 40. The robotic arms 40 include actuators 45, e.g., motors, transmissions, cables, drive shafts, etc., and sensors 43 configured to provide feedback for controlling the movement of the robotic arms 40. Sensors may include electrical sensors, torque sensors, force sensors, strain sensors, temperature sensors, position sensors, and the like. Each of the robotic arms 40 also includes an instrument drive unit (IDU) 52 that is configured to couple to an actuation mechanism of the attached device and is configured to move (e.g., rotate) and actuate the device. During endoscopic procedures, the endoscopic camera 12 may be inserted through an endoscopic access port (not shown) held by the robotic arm 40.

The surgeon console 30 includes a first screen 32, which displays a video feed of the surgical site provided by camera 12, and a second screen 34, which displays a user interface for controlling the surgical robotic system 10. The first screen 32 and second screen 34 may be touchscreens (e.g., monitors 72) allowing for displaying various graphical user inputs. In embodiments, the ultrasound images may be also displayed on the first and second screens 32 and 34. The surgeon console 30 also includes a plurality of user interface devices, such as foot pedals 36 and a pair of hand controllers 38a and 38b which are used by a user to remotely control robotic arms 40 and endoscopic camera 12.

The control tower 21 also acts as an interface between the surgeon console 30 and one or more robotic arms 40. In particular, the control tower 21 is configured to control the robotic arms 40, such as to move the robotic arms 40 and the attached devices, based on a set of programmable instructions and/or input commands from the surgeon console 30, in such a way that robotic arms 40 and the attached device execute a desired movement sequence in response to input from the foot pedals 36 and the hand controllers 38a and 38b. The foot pedals 36 may be used to enable and lock the hand controllers 38a and 38b, repositioning the endoscopic camera 12. In particular, the foot pedals 36 may be used to perform a clutching action on the hand controllers 38a and 38b. Clutching is initiated by pressing one of the foot pedals 36, which disconnects (i.e., prevents movement inputs) the hand controllers 38a and/or 38b from the robotic arm 40 and the attached device. This allows the user to reposition the hand controllers 38a and 38b without moving the robotic arm(s) 40 and the endoscopic camera 12. This is useful when reaching control boundaries of the surgical space.

The present disclosure provides a system and method to verify calibration of a stereoscopic camera, i.e., camera 12, without using additional calibration targets and with minimal interruption to the surgical workflow. This quick verification may be performed either in the operating room before the surgical procedure or intra-operatively during the surgical procedure.

The camera may be a stereoscopic camera that may be calibrated prior to use in a surgical setting. Calibration may be performed using a calibration pattern, which may be a checkerboard pattern of black and white squares. The calibration pattern may be disposed on one of the instruments 50, e.g., on the shaft. In embodiments, the calibration pattern may be disposed on one of the access port 55 either inside the cannular portion of the access port or on the outside. The calibration pattern may then be used while the camera 51 is inserted into the access port 55. Insertion or any other movement of the camera 51 may be paused to allow for the calibration pattern to be imaged by the camera 51. In additional embodiments, custom calibration pattern can be etched or otherwise attached on one of the robotic arms 40a-d and the robotic arm 40 holding the camera 51 may be manipulated either manually or automatically, e.g., programmed with waypoints, to capture calibration pattern images for camera calibration. Furthermore, current calibration parameters can be validated based on the measured distances of calibration pattern with respect to the calibration patterns as described above.

In further embodiments, the calibration pattern may be projected by a projector disposed on the endoscope 14, which may include a light source (e.g., an LED) and a slide or a lens having the calibration pattern disposed thereon (e.g., etched, printed, etc.). In additional embodiments, the calibration pattern may be disposed on a collapsible (e.g., foldable or rollable) sheet which is expanded or unfolded inside the patient. The calibration pattern may be inserted in the collapsible form through one of the access ports 55a-d, used for calibration, collapsed, and then withdrawn. In additional embodiments, the calibration pattern may be disposed in a calibration-capable trocar (e.g., on a collapsible flap at the bottom of the trocar with a calibration pattern etched on the flap). The calibration process may be performed during endoscope insertion through the calibration-capable trocar. This process may require stopping the endoscope insertion through trocar at a certain depth while endoscope camera head is inside the trocar, capturing a few images of the calibration pattern on the calibration flap of the trocar, performing calibration and instructing user to further push the endoscope through the trocar for full insertion.

The calibration may include obtaining a plurality of images at different poses and orientations and providing the images as input to an image processing unit, which outputs calibration parameters for use by the camera during use. Calibration parameters may include one or more intrinsic and/or extrinsic parameters including, but not limited to, position of the principal point, focal length, skew, sensor scale, distortion coefficients, rotation matrix, translation vector, and the like. The calibration parameters may be stored in a memory of the camera 12 and loaded by the image processing unit 20 upon connecting to the camera 12.

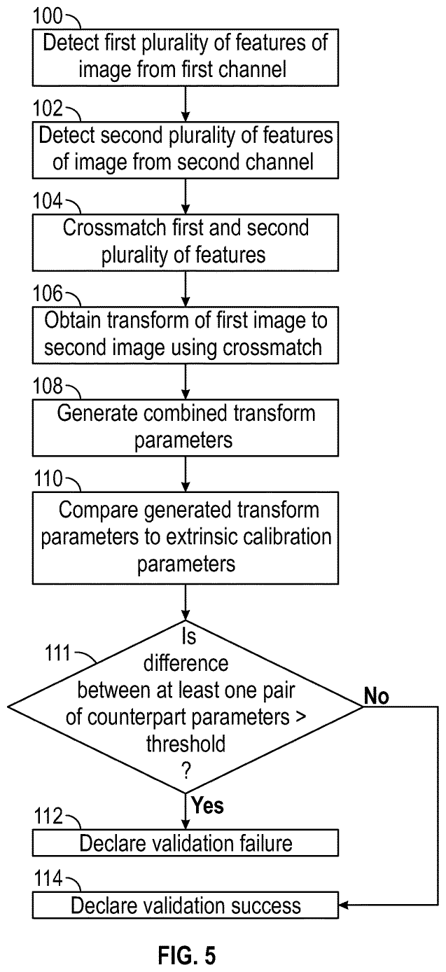

With reference to FIG. 5, a method for calibrating the camera 12 and the endoscope 14 includes calibrating the sensors 80a and 80b of the camera 12 by detecting features from each channel of the image separately (i.e., from each of the sensors 80a and 80b), then performing feature matching from the features detected in one channel to the features detected in the other channel. Feature matching is performed using keypoint detector and descriptor combination including but not limited to Oriented FAST and Rotated BRIEF (ORB) features in the image processing unit 20.

After performing feature matching using the robust keypoint descriptors, the relative transform between the two cameras of the stereo endoscope is estimated. The system then estimates the intrinsic and extrinsic camera parameters based on the initial factory calibration parameters and the estimated transform based on feature matching. After performing rectification using the existing intrinsic and extrinsic camera parameters, the detected features from one channel are checked to see if they match on the epipolar lines of the other channel and vice versa. An affine transformation matrix is then formed to transform the image from one channel to the other channel. This transformation matrix is compared to a preset threshold, e.g., +/−1% deviation, to be within the tolerance range of the existing parameters. If the matrix is outside the tolerance range, then the test fails and the camera 12 and the endoscope 14 are deemed unusable for the surgical procedure. The image processing unit 20 outputs an alert on one of the monitors 72 and prevents further use of the camera 12 and the endoscope 14 with the imaging system 10.

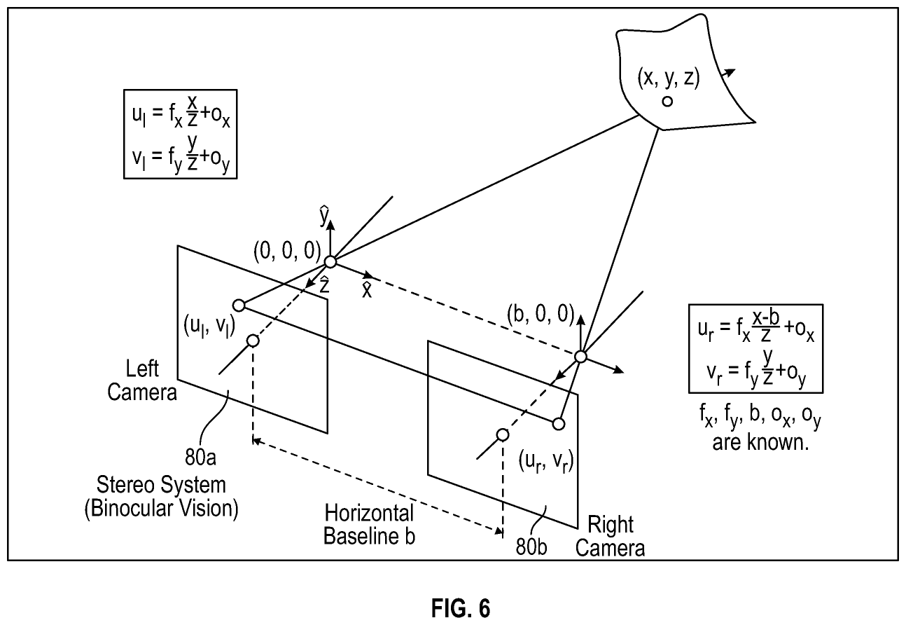

With reference to FIG. 6, which schematically illustrates the calibration process of FIG. 5, at step 100, the image processing unit 20 detects features from a first (e.g., right) channel to obtain first plurality of features (FEATS_C1). The features may be detected using oriented FAST and rotated BRIEF (ORB) feature detector, which is a computer vision algorithm used in object recognition or 3D reconstruction. The ORB feature detector itself is based on features from accelerated segment test (FAST) keypoint detector and a binary robust independent elementary features (BRIEF) visual descriptor. Any suitable computer vision features detector, descriptor and matching algorithm may be used.

At step 102, the image processing unit 20 detects features from the second (e.g., left) channel to obtain second plurality of features (FEATS_C2). The features of the second channel are detected in the same manner as the those of the first channel. At step 104, the image processing unit 20 crossmatches the features detected from first channel into the second channel image to obtain crossmatch of the features (FEATS_C1xC2). Any suitable image matching algorithm may be used, such as, fast library for approximate nearest neighbors (FLANN), which is an image matching algorithm for fast approximate nearest neighbor searches in high dimensional spaces. FLANN projects high-dimensional features to a lower-dimensional space and then generates the compact binary codes.

At step 106, the image processing unit 20 estimates the transform from the first channel to the second channel based on the crossmatch of features FEATS_C1xC2 to obtain transform of the crossmatch (TRANS_C1xC2) using an outlier tolerant transformation estimation algorithm. In embodiments, a random sample consensus (RANSAC) algorithm may be used to estimate a mathematical model from a data set that contains outliers by identifying the outliers in a data set and estimating the desired model using data that does not contain outliers.

At step 108, the image processing unit 20 generates a combined transform that describes the extrinsic camera parameters to transform the salient points of the image from one channel (e.g., first channel) to the other channel (e.g., second channel) to obtain a generated, combined transform parameters (TRANS).

At steps 110 and 111, the image processing unit 20 compares the generated transform parameters (TRANS) to the pre-determined extrinsic camera calibration parameters. A difference between corresponding transform and calibration parameters is calculated and then compared to a threshold (DEL). If the tested and the pre-determined extrinsic camera calibration parameters are more than the threshold apart, i.e., the difference is larger than the threshold, the image processing device 20 declares validation failure at step 112 via an alert, advising the user to replace the laparoscopic camera 12 and/or endoscope 14. If the test is successful, the image processing device 20 indicates via a successful prompt at step 114 that the camera 12 and the endoscope 14 may be used.

In addition to calibration patterns, additional objects, such as one or more instruments 50 may be used for calibration. The instruments 50 include various landmarks, e.g., fasteners, edges, components, having unique shapes and known dimensions, which may be used as calibration patterns. The instruments 50 may be detected during use of the camera 12 and detected landmarks of the instruments 50 may be used to optimize calibration parameters.

Instruments 50 may be detected in the video feed captured by the camera 12 using any image processing algorithm, which may be an artificial intelligence or a machine learning (AI/ML) algorithm. Images or video feed of instruments and their particular landmarks may be used as a data set for training the AI/ML detection algorithm.

Once instruments are detected, the AI/ML algorithm also detects landmarks of the instruments. After the landmarks are detected, a depth mapping algorithm may then be used to measure distances between instrument landmarks in 3D using existing stereo calibration. The distances may then be used to optimize calibration parameters to minimize the difference between measured and actual instrument shapes and sizes.

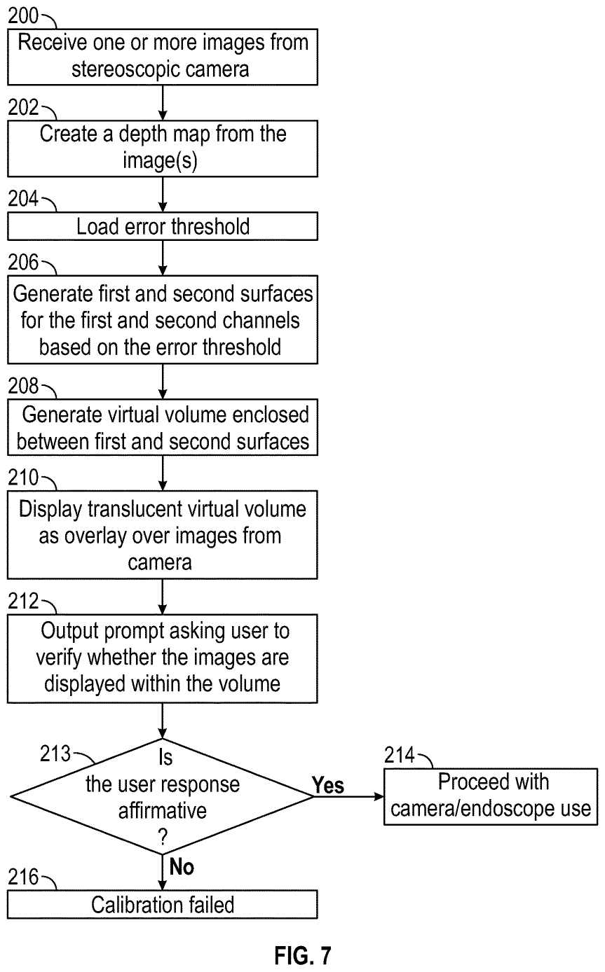

Another embodiment of the present disclosure describes a verification method based on generation of a stereo reconstruction using the existing intrinsic and extrinsic camera parameters. The flow chart of FIG. 7 describes a stereo reconstruction-based verification algorithm, which may be embodied as software instructions executable by the image processing unit 20. At step 200, the image processing unit 20 receives one or more images (SCENE) from the camera 12. The images may be obtained while the camera 12 is held stationary for brief period of time (e.g., 2-5 seconds) to capture at least one or more frames. The scene may be a surgical scene or any other scene.

At step 202, the image processing unit 20 creates a depth map (DEPTH) of the viewed scene using the pre-determined calibration parameters. The depth map may also include a surface normal map, which uses RGB information that corresponds to the X, Y and Z axes in 3D space. Any suitable depth map generating algorithm may be used, such as depth map automatic generator (DMAG) and the like. At step 204, the image processing unit 20 loads an acceptable error (ERR) threshold in reconstructing the surface. The error threshold may be stored in a memory of the camera 12 and denotes a difference value between the depth map and the images and may be stored on the storage device 73. At step 206, the image processing unit 20 creates two surfaces from the frame of reference of each of the first and second channels, whose distance from the reconstructed surface (depth map) is +/− threshold distance based on the loaded error threshold (ERR).

In embodiments, the threshold may be part of the software being executed by the image processing unit 20. The threshold may be stored in memory, which may store a plurality of thresholds and a suitable one is selected based on the type (e.g., model) of the camera 12 being used. In further embodiments, the threshold may be adjustable by the user via a graphical user interface of the image processing unit 20. The user-adjusted threshold may be saved as part of surgeon preferences.

At step 208, the image processing unit 20 creates a virtual error volume (ERR VOL) that is enclosed between the two surfaces created at step 206. The virtual error volume represents the acceptable error. At step 210, the image processing unit 20 displays a translucent image of the virtual error volume ERR VOL. The image processing unit 20 overlays the translucent image of the virtual error over the images from the channels that was used to create the depth map. The image processing unit 20 displays the overlayed image (ERR VOL OVER SCENE) on one of the monitors 72 and/or screens 32 and 34. In embodiments, the overlayed image may be displayed on a headset, which may be a virtual reality or an augmented reality headset such as HOLOLENS® from Microsoft, of Redmond, WA, META QUEST PRO® available from Meta, of Menlo Park, CA.

At steps 212 and 213, the image processing unit 20 outputs a prompt asking the user to verify that the images (SCENE) from the camera 12 is seen within the ERR VOL. If the response is affirmative, the image processing unit 20 states that calibration has passed and proceeds with use of the camera 12 at step 214. The image processing device 20 indicates via a successful prompt that the camera 12 and the endoscope 14 may be used and the image processing device 20 enables the camera 12 for imaging and the camera 12 may be used to image the surgical site.

If the response is negative, at step 216 the image processing unit 20 outputs an alert stating that calibration validation failed and advises the user to replace the laparoscopic camera 12 and/or endoscope 14. In embodiments, following validation failure, the verification algorithm may be repeated prior to recommending replacement of the camera 12 and/or endoscope 14.

In further embodiments, comparison of the volume and the images from the camera 12 may be performed using a computer vision algorithm rather than relying on user verification. The image processing device 20 is configured to automatically determine if the first and second image are displayed within the virtual volume, based on the threshold. An AI/ML image processing algorithm may be used to determine position of the volume relative to the thresholds.

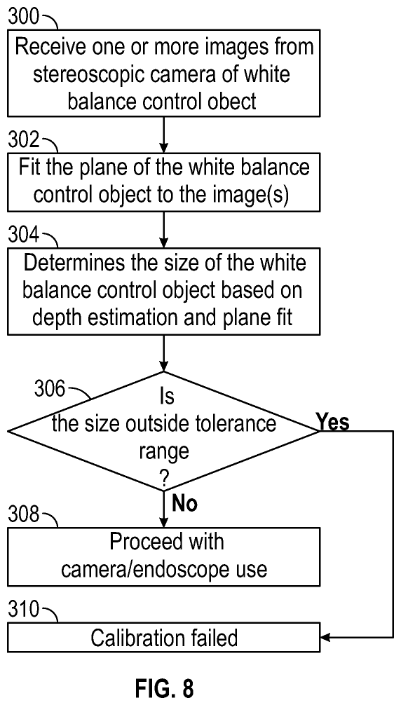

The method of FIG. 7 may also be implemented during white balance calibration of the camera 12 and the endoscope 14 and includes calibrating white balance of the sensors 80a and 80b of the camera 12. The sensors 80a and 80b provide RGB color imaging and provide color and texture information to surgeons during surgical procedures. Camera color and texture information may drift over time requiring a white balance adjustment of the camera 12. FIG. 8 shows a method for white balance calibration during the stereoscopic calibration of the method of FIG. 7. With reference to FIG. 8, at step 300, the image processing unit 20 receives one or more images of a white balance control object, e.g., sheet of white paper from the camera 12. At step 302 the image processing unit 20 verifies if the extrinsic camera parameters are within operable range by imaging the white balance control object. The image processing unit 20 fits the plane of the white balance control object to the image in each channel and measures the depth using stored existing intrinsic and extrinsic camera parameters at step 302. The image processing unit 20 then determines the size of the of the white balance control object based on depth estimation and plane fit at step 304. The image processing unit 20 then compares the size to a tolerance range, which may be +/-1% to pass the test step 306. If the size is within the tolerance range, then the camera 12 is calibrated and may be used and at step 308, the image processing unit 20 outputs a corresponding success message. If the size is outside the tolerance range, then the camera 12 is not properly calibrated and at step 310, the image processing unit 20 outputs a corresponding failure message.

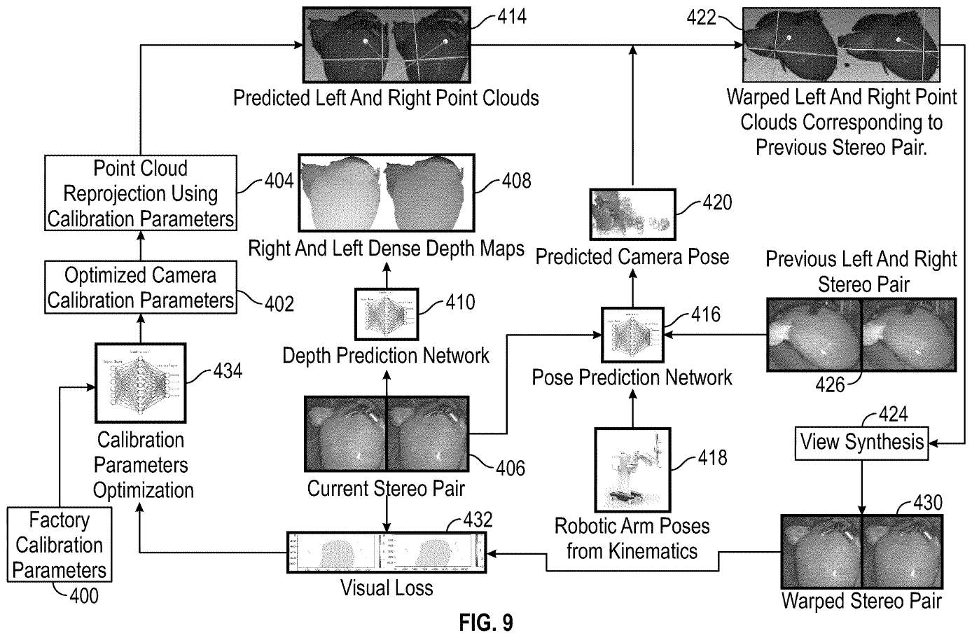

FIG. 9 shows an intra-operative calibration workflow that does not require any checkerboard patterns for calibration using the surgical robotic system 10 of FIG. 4. Rather, this workflow uses a few frames from the initial exploration phase of the procedure to optimize the camera calibration parameters if needed. At step 400, the camera 12 and the endoscope 14 are calibrated, which may be the initial factory calibration or last optimized camera calibration parameters stored in the memory of the endoscope 14 or on the system 10 for each endoscope 14 separately based on the unique serial number of each stereo endoscope 14.

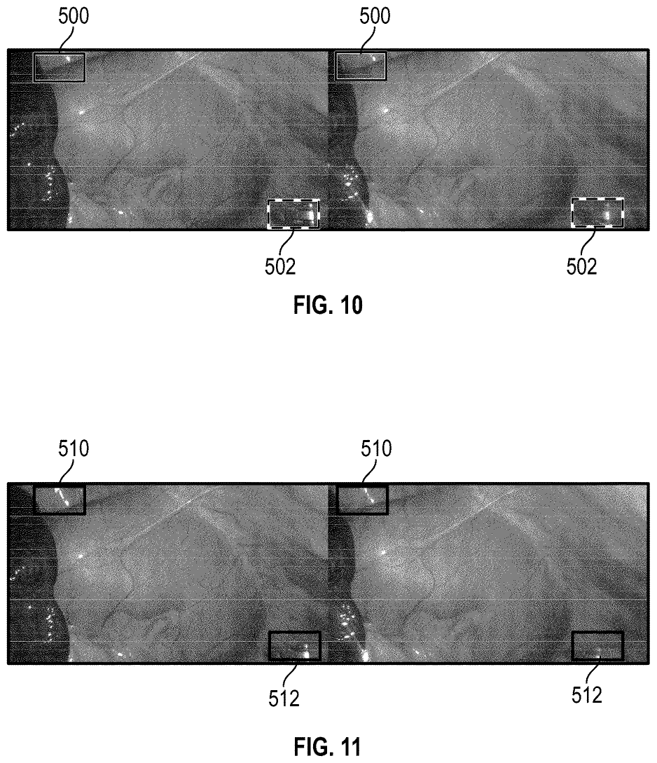

FIGS. 10 and 11 show stereo pair images from the camera 12 obtained during an RAS procedure. FIG. 10 shows left and right stereo pair rectified images using accurate camera calibration parameters, whereas FIG. 11 shows the same stereo pair image rectified using sub-optimal camera calibration parameters. The mismatch in the same direction of images between left and right stereo pair images causes noisy dense depth maps and erroneous stereo reconstruction. In FIG. 10, rectangles 500 and 502 show similar content in the same (e.g., vertical) direction showing highly accurate camera calibration. In FIG. 11, rectangles 510 and 512 show dissimilar content in the same direction due to inaccurate camera calibration.

At step 402, the system 10 loads the most recent optimized camera calibration parameters and step 404 using the current stereo pair images 406, the system 10 first predicts the dense depth maps 408 using stereo reconstruction through a depth prediction network 410. The system 10 predicts dense depth map 408 from both left and right camera image perspectives. At step 412, the dense depth maps 408 are then used along with the camera calibration parameters to generate predicted point clouds 414 with respect to left and right channel images.

The system 10 is also configured to predict the camera pose by processing the current and previous images through a pose prediction network 416 in the form of visual SLAM. The pose network 416 uses robotic arm kinematics data 418 as well as the previous and current set of images to estimate the location and pose 420 of endoscope 14. The system 10 further generates warped point clouds 422 based on the predicted pose corresponding to the previous stereo pair images 426, which are provided to the pose network 416. The system 10, at step 424 then uses the warped point clouds to synthesize the warped stereo pair images 430 representing the first stereo pair to generate the visual loss function image 432. The visual loss image 432 represents the calibration parameters error and is then passed to a calibration parameters optimization network 434, which optimizes the camera calibration parameters. The depth prediction network 410, the pose prediction network 416, and the optimization network 434 may be any suitable deep learning network (e.g., Convolutional Neural Network, Recurrent Neural Network, Deep Reinforcement Network, Deep Belief Network, Transformer Network, etc.), which may be trained on image and video data and corresponding camera calibration parameters.

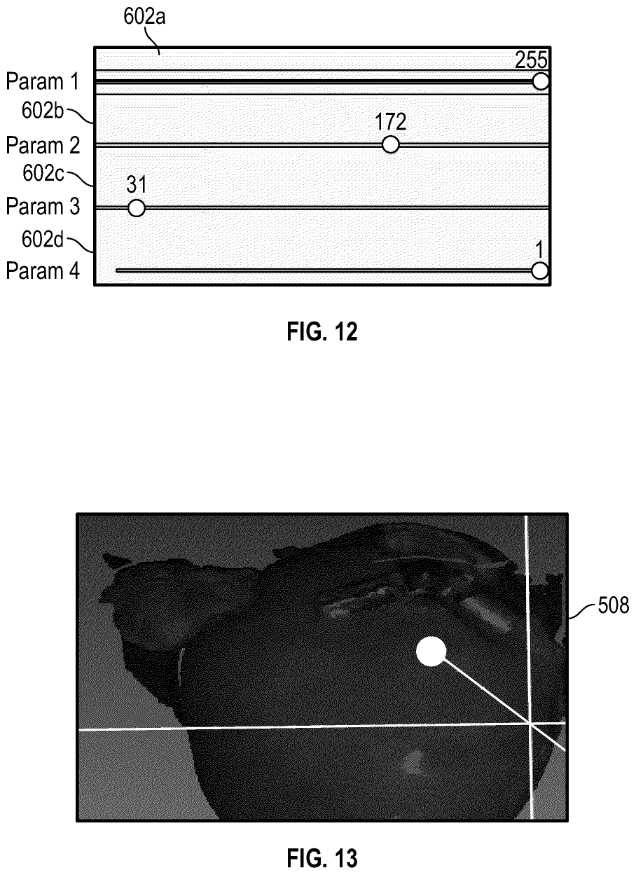

With reference to FIG. 12, a GUI 600 is shown, which may be displayed on one of the screens 32, 34. The GUI 600 outputs optimized calibration parameters and allows for user modification of those parameters in real time while observing the image. The impact of the rectification on the images is also shown in FIGS. 10 and 11 where parallel (e.g., vertical) lines represent how the left and right images were shifted. The GUI 600 includes a plurality of inputs 602a-d, each of which allows for controlling a single calibration parameter. Calibration parameters may include one or more intrinsic and/or extrinsic parameters including, but not limited to, position of the principal point, focal length, skew, sensor scale, distortion coefficients, rotation matrix, translation vector, and the like. Each of the inputs 602a-d may be a slider, a drop-down menu, or any other GUI adjustment selector suitable for changing numerical values. As the calibration parameters are changed through the GUI 600, the images of FIGS. 10 and 11 are adjusted in real time along with a point cloud 508 shown in FIG. 13. In one embodiment, these interactively-optimized endoscope-specific calibration parameters may be saved along with the endoscope camera serial number in the system every time the calibration parameters are updated. In another embodiment, the calibration parameters may be saved in the endoscope camera programmable memory every time the calibration parameters are updated. In further embodiments, the calibration parameters may be saved as part of specific user's preferences.

While several embodiments of the disclosure have been shown in the drawings and/or described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope of the claims appended hereto.

1-15. (canceled)

16. An imaging system comprising:
a stereoscopic camera including a first sensor configured to output a first image in a first channel and a second sensor configured to output a second image in a second channel; and
an image processing device coupled to the stereoscopic camera, the image processing device including a processor configured to:
detect a first plurality of features in the first image of the first channel;
detect a second plurality of features in the second image of the second channel;
generate a crossmatch of the first and second plurality of features;
transform the crossmatch to obtain a plurality of transform parameters;
compare the plurality of transform parameters to a plurality of extrinsic calibration parameters of the stereoscopic camera;
validate calibration of the stereoscopic camera based on comparison of the plurality of transform parameters to the plurality of extrinsic calibration parameters; and
output a message indicating whether calibration of the stereoscopic camera is validated.

17. The imaging system according to claim 16, further comprising a monitor configured to display the first image and the second image.

18. The imaging system according to claim 17, wherein the monitor is further configured to display the message indicating whether the calibration of the stereoscopic camera is validated.

19. The imaging system according to claim 16, wherein the processor is further configured to compare a difference between at least one transform parameter of the plurality of transform parameters to at least one calibration parameter of the plurality of extrinsic calibration parameters to a threshold.

20. The imaging system according to claim 19, wherein the message is an alert indicating validation of the calibration failed, and the processor is further configured to generate the alert in response to the difference being larger than the threshold.

21. The imaging system according to claim 19, wherein the message is a prompt indicating validation of the calibration succeeded, and the processor is further configured to generate the prompt in response to the difference being smaller than the threshold.

22. The imaging system according to claim 19, wherein the processor is further configured to load the threshold from the stereoscopic camera.

23. An imaging system comprising:
a stereoscopic camera including a first sensor configured to output a first image in a first channel and a second sensor configured to output a second image in a second channel; and
an image processing device coupled to the stereoscopic camera, the image processing device including a processor configured to:
generate a depth map based on the first image of the first channel and a depth map based on the second image of the second channel;
generate a first surface based on the depth map for first channel;
generate a second surface based on the depth map for the second channel;
generate a virtual volume enclosed between the first surface and the second surface; and
display the virtual volume over the first image and the second image.

24. The imaging system according to claim 23, further comprising a monitor configured to display the virtual volume over the first image and the second image.

25. The imaging system according to claim 24, wherein the processor is further configured to output on the monitor a prompt asking whether the first image and the second image are displayed within the virtual volume.

26. The imaging system according to claim 25, wherein the processor is further configured to receive a user response in response to the prompt.

27. The imaging system according to claim 26, wherein the processor is further configured to output an alert indicating calibration validation failed in response to a negative user response.

28. The imaging system according to claim 26, wherein the processor is further configured to output a message indicating calibration validation succeeded in response to an affirmative user response.

29. The imaging system according to claim 23, wherein the processor is further configured to generate the virtual volume based on an error value.

30. The imaging system according to claim 29, wherein the processor is further configured to load the error value from the stereoscopic camera.

31. A method for validating calibration of a stereoscopic camera, the method comprising:
capturing a first image in a first channel at a first sensor of a stereoscopic camera;
capturing a second image in a second channel at a second sensor of the stereoscopic camera;
generating, at a processor, a depth map based on the first image of the first channel and a depth map based on the second image of the second channel;
generating, at the processor, a first surface based on the depth map for first channel;
generating, at the processor, a second surface based on the depth map for the second channel;
generating, at the processor, a virtual volume enclosed between the first surface and the second surface; and
displaying the virtual volume over the first image and the second image.

32. The method according to claim 31, further comprising displaying on a monitor the virtual volume over the first image and the second image.

33. The method according to claim 32, further comprising outputting on the monitor a prompt asking whether the first image and the second image are displayed within the virtual volume.

34. The method according to claim 33, wherein receiving, at the processor, a user response to the prompt.

35. The method according to claim 34, further comprising:
outputting on the monitor an alert indicating calibration validation failed in response to a negative user response; and
outputting on the monitor a message indicating calibration validation succeeded in response to an affirmative user response.
